(19) United States
(12) Patent Application Publication
(10) Pub. No.: US 2026/0195817 A1
(43) Pub. Date: Jul. 9, 2026

(54) System and Method for funding group events or projects using a peer-to-peer non-revocable electronic contract

(71) Applicant: Jonathan Michael Kaplan, Austin, TX (US)

(72) Inventor: Jonathan Michael Kaplan, Austin, TX (US)

(21) Appl. No.: 19/172,968

(22) Filed: Apr. 8, 2025

Related U.S. Application Data
(60) Provisional application No. 63/633,597, filed on Apr. 12, 2024.

(51) Int. Cl. G06Q 40/06; G06Q 20/36; G06Q 20/40

(52) U.S. Cl. CPC G06Q 40/068; G06Q 20/36; G06Q 20/405; G06Q 20/407; G06Q 2220/00

(57) ABSTRACT

A system and method is presented that solves a long-standing problem in coordinating social consensus when securing funding for group campaigns or projects. The system enables creators to define minimum funding goals, participant requirements, and deadlines. Participants can pledge funds from their digital wallets, and only if all conditions are satisfied does the smart contract automatically transfer funds to the campaign creator. If the requirements are not met, no funds are moved. This approach ensures trustless coordination, improves group funding efficiency, and eliminates the need for centralized financial intermediaries.

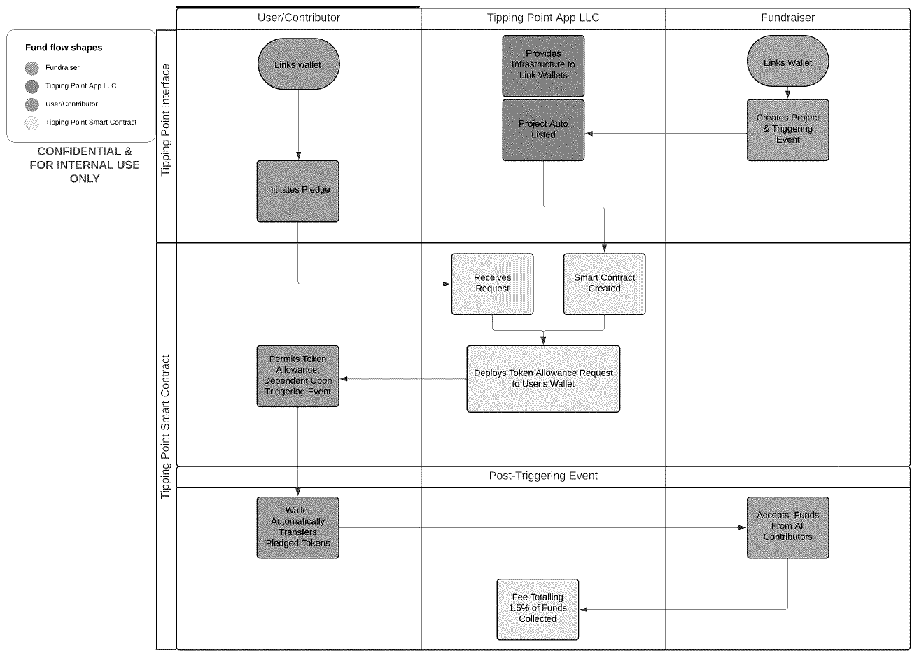

The invention proposed here is Tipping Point, a web application that allows users to connect a web3-enabled digital wallet (designed to custody and send/receive cryptocurrency payments) and create campaigns with specified minimums (and optional maximums) for the number of participants and amount of money needed for the campaign or project to take place, along with a deadline by which invitees must respond.

Invited users can log in to the app with their own web 3 wallet to opt-in to campaigns to which they've been invited, and by doing so pledge a certain financial contribution. If, prior to or by the deadline, the campaign reaches its minimum attendance and funding requirements, the campaign “tips” and invitee funds are automatically sent to the campaign creator. The transfer of funds is facilitated by a series of smart contracts on a decentralized blockchain network. Campaign creators can choose from multiple types, including those that dynamically adjust per-user pricing based on participation.

Prior art such as Tilt.com provided partial solutions to group coordination, but lacked decentralization and seizure resistance. Tipping Point eliminates these shortcomings by never taking custody of user funds and replacing trusted third parties with autonomous smart contracts.

### BRIEF DESCRIPTION OF THE DRAWINGS

The single drawing illustrates an example system architecture for the Tipping Point platform.

1: A system for coordinating conditional group contributions for a campaign or project, comprising:
a. a non-custodial smart contract deployed on a blockchain network;
b. a user interface configured to:
i. receive campaign parameters from a creator including a funding goal, a minimum number of participants, and a deadline;
ii. enable participants to pledge a specified amount of digital currency from a self-custodied wallet;
c. logic within the smart contract configured to:
i. track pledges without transferring funds until conditions are met;
ii. calculate a per-user contribution dynamically based on total participant count, when applicable;
iii. verify that both the funding goal and minimum participant threshold are met before the deadline;
iv. trigger automatic disbursement of funds from participant wallets to the campaign creator only if all conditions are satisfied;
d. wherein the smart contract executes the transfer of funds without intermediary custody and charges a service fee only upon successful execution.

2: A method for funding a group campaign using a peer-to-peer non-revocable smart contract, comprising:
a. receiving, via a user interface, a campaign creation request including a funding goal, minimum participant count, and deadline;
b. generating a smart contract on a blockchain that enforces the campaign parameters;
c. enabling potential participants to connect a digital wallet and pledge an amount of cryptocurrency without transferring funds;
d. monitoring pledged amounts and participant counts until the deadline;
e. upon detecting that the funding goal and participant minimum are satisfied before the deadline:
i. initiating transfer of pledged amounts from participant wallets to the campaign creator's wallet;
ii. allocating a service fee from each pledge to a designated treasury address;
f. automatically canceling fund transfers if the campaign does not meet conditions by the deadline.

3: The system of claim 1, wherein the digital currency is a stablecoin compatible with the ERC-20 standard.

4: The system of claim 1, wherein the per-user contribution amount decreases as additional participants opt in.

5: The method of claim 2, wherein the pledges are made in USDC and funds are disbursed using a single atomic transaction.

6: The system of claim 1, further comprising a gas abstraction module that enables gasless transactions using account abstraction.

7: The method of claim 2, further comprising sending notifications to participants upon tipping or expiration of the campaign.
